(19) United States
(12) Patent Application Publication
(10) Pub. No.: US 2019/0143892 A1
(43) Pub. Date: May 16, 2019

(54) ALERT CONTROL APPARATUS, ALERT CONTROL METHOD, AND RECORDING MEDIUM

(71) Applicant: OMRON Corporation, Kyoto-shi (JP)

(72) Inventors: Tadashi HYUGA, Hirakata-shi (JP); Tomoyoshi AIZAWA, Kyoto-shi (JP); Hatsumi AOI, Kyotanabe-shi (JP); Yoshio MATSUURA, Kasugai-shi (JP); Masato TANAKA, Kizugawa-shi (JP); Keisuke YOKOTA, Kasugai-shi (JP); Hisashi SAITO, Kasugai-shi (JP)

(73) Assignee: OMRON Corporation, Kyoto-shi (JP)

(21) Appl. No.: 16/175,768

(22) Filed: Oct. 30, 2018

(30) Foreign Application Priority Data
Nov. 15, 2017 (JP) 2017-219755

(51) Int. Cl. B60Q 9/00; G06K 9/00

(52) U.S. Cl. CPC B60Q 9/00; H04W 4/44; G06K 9/00845

(57) ABSTRACT

An alert to distracted driving may adversely lower the attention of the driver. An alert control apparatus (300) includes data obtaining units (41 to 43) that obtain sensing data (a to j) from sensors (6 to 15), a railroad crossing recognizer (44) that recognizes a position of a railroad crossing relative to a vehicle based on the sensing data, and a crossing entry determiner (45) that determines whether the vehicle has entered the railroad crossing based on the sensing data, and an alert controller (48) that restricts generation of an alert to distracted driving from a distracted driving alert device (200) while the vehicle is passing the railroad crossing.

### CROSS-REFERENCE TO RELATED APPLICATION

This application claims priority to Japanese Patent Application No. 2017-219755 filed on Nov. 15, 2017, the entire disclosure of which is incorporated herein by reference.

### FIELD

The present invention relates to an alert control apparatus for controlling an alert device that alerts a driver of a vehicle, an alert control, method, and a recording medium.

### BACKGROUND

A known alert device alerts a vehicle driver to distracted driving to prompt safe driving. This type of alert device detects the behavior of the vehicle or directly the condition of the driver, and determines distracted driving of the driver based on the detection result. However, distinguishing between underattentive driving and looking in different directions for safety checking is difficult. An alert can sometimes be annoying, or rather dangerous for a driver looking in different directions to check the surroundings for safety. Techniques have thus been developed to correctly recognize the situation and disable an alert to distracted driving as appropriate.

For example, Patent Literature 1 describes a technique for monitoring the operation of the steering wheel or the speed of the vehicle and disabling an alert to distracted driving when the driver is allowed to look in directions other than in front of the vehicle (e.g., when rounding a curve, reversing, or stopping).

### CITATION LIST

### Patent Literature

Patent Literature 1: Japanese Unexamined Patent Application Publication No. 06-243367

### SUMMARY

### Technical Problem

However, only monitoring the operation of the steering wheel or the vehicle speed can still allow generation of an unintended alert to distracted driving. For example, an alert may be generated when the vehicle passes a railroad crossing. At railroad crossings or in other similar situations, the driver checks the surroundings more carefully. However, an alert to distracted driving in such situations may adversely lower the attention of the driver.

One or more aspects of the present invention are directed to an alert control apparatus, an alert control method, and a recording medium that control an alert device without disturbing a driver of a vehicle at railroad crossings.

In response to the above issue, the aspects of the present invention may be implemented in the manner described below.

### Solution to Problem

An alert control apparatus according to a first aspect of the present invention is installable in a vehicle to control an alert device that alerts a driver. The apparatus includes a data obtaining unit that obtains sensing data from a sensor included in the vehicle, a gaze detector that detects a gaze or a face orientation of the driver based on the obtained sensing data, a distracted driving determiner that determines distracted driving of the driver based on the detected gaze or face orientation and a determination criterion for detecting distracted driving of the driver, a controller that causes the alert device to generate an alert in response to detection of distracted driving, a railroad crossing recognizer that recognizes a position of a railroad crossing relative to the vehicle based on the obtained sensing data, and a restrictor that restricts, based on a recognition result from the railroad crossing recognizer, generation of the alert to distracted driving of the driver from the alert device while the vehicle is passing the railroad crossing.

An alert control apparatus according to a second aspect of the present invention is the alert control apparatus according to the first aspect in which the restrictor changes the determination criterion to a criterion with which the alert is less likely to be generated while the vehicle is passing the railroad crossing than at other times.

An alert control apparatus according to a third aspect of the present invention is the alert control apparatus according to the second aspect in which the determination criterion includes a retention allowable duration for which the driver is allowed to retain a gaze or a face orientation within an imaginary area defined for detecting distracted driving, and the restrictor extends the retention allowable duration from a predetermined value.

An alert control apparatus according to a fourth aspect of the present invention is the alert control apparatus according to the first aspect further including a storage that stores map data including at least position data about the railroad crossing, in which the sensing data includes position data about the vehicle, the data obtaining unit obtains the position data about the vehicle based on a positioning signal from a positioning system, and the railroad crossing recognizer recognizes the position of the railroad crossing relative to the vehicle based on the obtained position data about the vehicle and the position data about the railroad crossing included in the map data.

An alert control apparatus according to a fifth aspect of the present invention is the alert control apparatus according to the first aspect in which the vehicle includes an exterior view camera that obtains image data about a view external to the vehicle, the data obtaining unit obtains the image data from the exterior view camera, and the railroad crossing recognizer subjects the image data to image processing and uses the processed image data to recognize the position of the railroad crossing relative to the vehicle.

An alert control apparatus according to a sixth aspect of the present invention is the alert control apparatus according to the first aspect in which the vehicle is configured to communicate with a vehicle-to-roadside communication system or a vehicle-to-vehicle communication system, the data obtaining unit obtains surrounding data about the vehicle from the communication system, and the railroad crossing recognizer recognizes the position of the railroad crossing relative to the vehicle based on the surrounding data.

An alert control method according to a seventh aspect of the present invention is implemented by an alert control apparatus installable in a vehicle to control an alert device that alerts a driver. The method includes obtaining, with the alert control apparatus, sensing data from a sensor included in the vehicle, detecting, with the alert control apparatus, a gaze or a face orientation of the driver based on the obtained sensing data, determining, with the alert control apparatus, distracted driving of the driver based on the detected gaze or face orientation and a determination criterion for detecting distracted driving of the driver, causing, with the alert control apparatus, the alert device to generate an alert in response to detection of distracted driving, recognizing, with the alert control apparatus, a position of a railroad crossing relative to the vehicle based on the obtained sensing data, and restricting, with the alert control apparatus, generation of the alert to distracted driving of the driver from the alert device based on a recognition result while the vehicle is passing the railroad crossing.

A recording medium according to an eighth aspect of the present invention causes a computer to implement processes performed by the units included in the alert control apparatus according to any one of the first to sixth aspects.

### Advantageous Effects

The apparatus, method, and recording medium according to the first, seventh, and eighth aspects restrict alert generation while a vehicle is passing a railroad crossing. This structure prevents the driver from lowering his or her attention, and improves safety.

The apparatus according to the second aspect relaxes the determination criterion used by the alert device to generate an alert to a criterion with which the alert is less likely to be generated while the vehicle is passing a railroad crossing than at other times. This restricts alert generation from the alert device.

The apparatus according to the third aspect extends the retention allowable duration of a gaze retention duration set for determining distracted driving from a predetermined value while a vehicle is passing a railroad crossing. Extending the retention allowable duration sufficiently can restrict alert generation from the alert device.

The apparatus according to the fourth aspect obtains the position data about the vehicle based on the positioning signal from a positioning system, and recognizes the position of a railroad crossing relative to the vehicle based on the position data about the vehicle and the position data about the railroad crossing included in the prestored map data. This structure recognizes a railroad crossing with higher accuracy.

In the apparatus according to the fifth aspect, the exterior view camera installed in the vehicle obtains the exterior image data, which undergoes image processing and is then used to recognize the position of a railroad crossing relative to the vehicle. This structure autonomously recognizes a railroad crossing without relying on an external resource, such as a positioning system.

The apparatus according to the sixth aspect obtains the surrounding data about the vehicle from a vehicle-to-roadside communication system, which is used to recognize the position of a railroad crossing relative to the vehicle. The simple structure can recognize a railroad crossing by, for example, receiving information about the location of a railroad crossing from a vehicle-to-roadside communication system, which may typically be the Vehicle Information and Communication System (VICS, registered trademark), or with a radio wave beacon installed near a railroad crossing.

The method according to the seventh aspect can be used by an alert control apparatus incorporating an alert device.

### BRIEF DESCRIPTION OF THE DRAWINGS

FIG. 1A is a schematic diagram describing an example use of an alert control apparatus according to the present embodiment;

FIG. 1B is a schematic diagram describing an example use of an alert control apparatus according to the present embodiment;

FIG. 2 is a schematic diagram of a vehicle including an alert control apparatus implementing an alert control method according to the present invention;

FIG. 3 is a block diagram of the alert control apparatus according to one or more embodiments;

FIG. 4 is a schematic diagram describing example predetermined retention allowable durations included in a determination criterion;

FIG. 5 is a flowchart showing an example procedure performed by the alert control apparatus according to one or more embodiments;

FIG. 6 is a schematic diagram showing the control for restricting an alert to distracted driving; and

FIG. 7 is a flowchart showing another example procedure performed by the alert control apparatus according to one or more embodiments.

### DETAILED DESCRIPTION

One or more embodiments of the present invention will now be described with reference to the drawings.

### Example Use

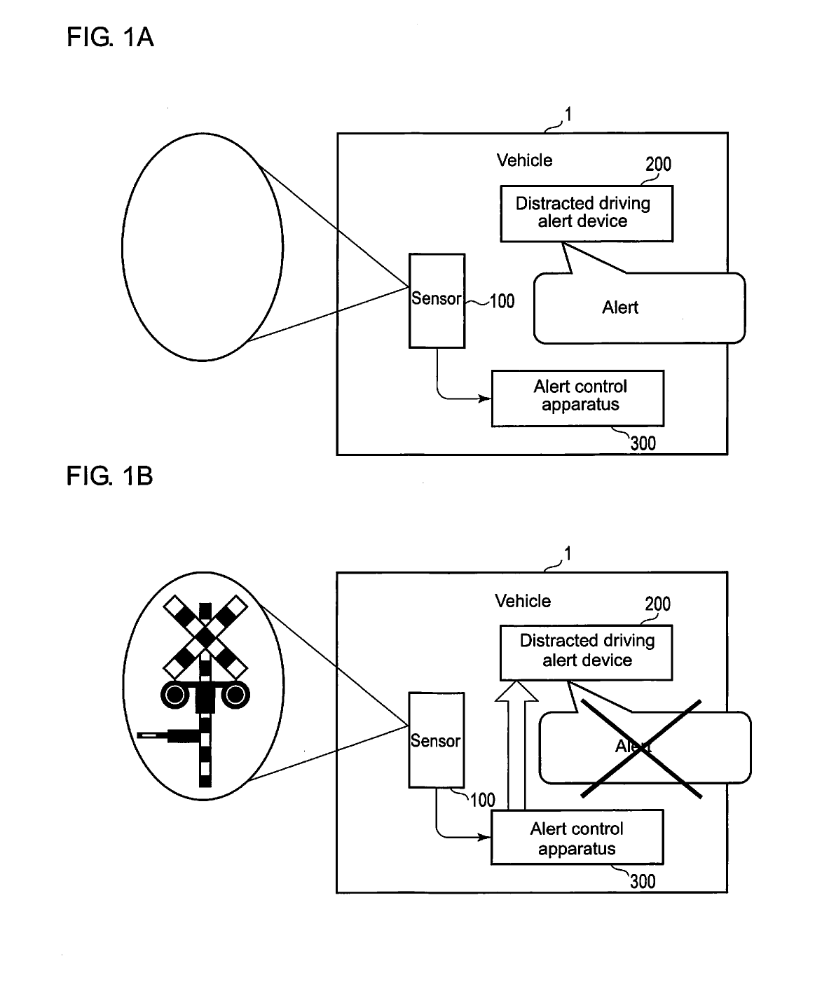

An example use of an alert control apparatus according to one or more embodiments of the present invention will now be described. FIGS. 1A and 1B are schematic diagrams describing an example use of the alert control apparatus according to the present embodiment.

A vehicle 1 includes an alert control apparatus 300 in addition to a sensor 100 and a distracted driving alert device 200. The sensor 100 obtains data about, for example, environments outside and inside the vehicle 1 and the conditions of the driver. For example, the sensor 100 obtains various items of sensing data with, for example, an exterior view camera, an interior view camera, a position measurement sensor such as a global positioning system (GPS) sensor, and a wireless beacon receiver.

The sensing data is transferred to the alert control apparatus 300. The alert control apparatus 300 subjects image data from the interior view camera to image processing to detect the gaze direction or the face orientation of the driver, and causes the distracted driving alert device 200 to generate an alert to distracted driving based on the detection result.

As shown in FIG. 1A, the distracted driving alert device 200 generates an alert to distracted driving when the gaze or face orientation of the driver is retained in a direction other than the traveling direction for a predetermined duration (e.g., several seconds). The alert may be a voice message stating, for example, “Stay alert, and keep your eyes on the road.”

When the sensor 100 detects a railroad crossing as shown in FIG. 1B, the alert control apparatus 300 controls the distracted driving alert device 200 not to generate an alert to distracted driving.

The alert control apparatus 300 with the above structure performs control for disabling an alert to distracted driving as described below when the vehicle 1 passes a railroad crossing.

The alert control apparatus 300 determines whether the vehicle 1 is approaching a railroad crossing using position data about the vehicle 1 obtained from a GPS sensor 12 and map data prestored in, for example, a car navigation system. When determining that the vehicle 1 is approaching a railroad crossing, the alert control apparatus 300 stops the processing for determining distracted driving or disables the output of a warning instruction signal from the alert control apparatus 300 while the vehicle 1 is passing the railroad crossing.

In this state, the driver's looking to the right and left for safety checking is not determined as distracted driving or does not cause the distracted driving alert device 200 to generate an alert. This prevents an unintended alert to distracted driving from being generated while the vehicle 1 is passing a railroad crossing, and allows the driver to continue driving in calm without being annoyed. One or more embodiments of the present invention will now be described in detail.

### EMBODIMENT

### Structure

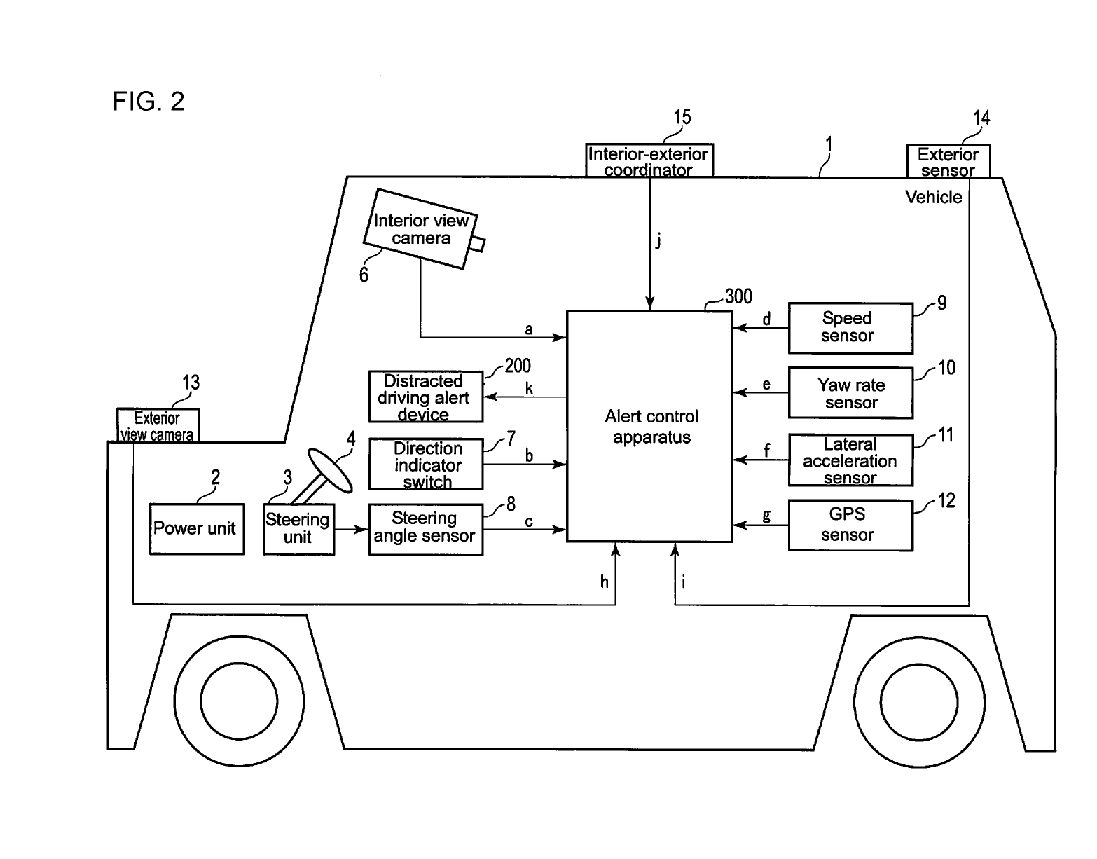

FIG. 2 is a schematic diagram of a vehicle including an alert control apparatus according to the present embodiment. The vehicle 1 includes, as its basic components, a power unit 2 including a power supply and a transmission, and a steering unit 3 incorporating a steering wheel 4. The vehicle 1 further includes, as processing blocks according to the embodiment, the alert control apparatus 300, an interior view camera 6, a direction indicator switch 7, a steering angle sensor 8, a speed sensor 9, a yaw rate sensor 10, a lateral acceleration sensor 11, a position measurement sensor, such as the GPS sensor 12, an exterior view camera 13, an exterior sensor 14, an interior-exterior coordinator 15, and the distracted driving alert device 200.

The alert control apparatus 300 obtains data, such as image data, sensing data, and reception data, from the interior view camera 6, the direction indicator switch 7, the steering angle sensor 8, the speed sensor 9, the yaw rate sensor 10, the lateral acceleration sensor 11, the GPS sensor 12, the exterior view camera 13, the exterior sensor 14, and the interior-exterior coordinator 15. The alert control apparatus 300 causes the distracted driving alert device 200 to generate an alert when detecting, based on the data items, distracted driving of the driver while the vehicle 1 is traveling straight.

The alert control apparatus 300 determines distracted driving by, for example, determining whether the face orientation or gaze direction of the driver of the vehicle 1 is continuously retained in a predefined distracted driving determinant area longer than for a predetermined duration. The determination may also use the speed and the steering angle of the vehicle 1 as its criteria.

The distracted driving alert device 200 is installed in the vehicle interior. The distracted driving alert device 200 includes, for example, a speaker that outputs an alert sound or an alert voice message, a display for displaying an alert massage, or a vibrator that provides a vibrating alert. The distracted driving alert device 200 generates an alert in response to a warning instruction signal k output from the alert control apparatus 300. The distracted driving alert device 200 may also be a mobile terminal.

The interior view camera 6 faces the driver to capture an image of, for example, the upper body of the driver, and outputs an image data signal a to the alert control apparatus 300. The interior view camera 6 may capture images of the driver either constantly while the vehicle 1 is operating or in response to a request from the alert control apparatus 300.

The direction indicator switch 7 outputs, to the alert control apparatus 300, a direction indicator signal b corresponding to a direction in which the driver intentionally directs the vehicle 1 to turn right or left or to change the lane.

The steering angle sensor 8 outputs, to the alert control apparatus 300, a steering angle signal c corresponding to the steering direction, the neutral position, and the steering angle in accordance with the operation of the steering unit 3.

The speed sensor 9 detects the speed of the vehicle 1, and outputs a detection signal d corresponding to the detected speed to the alert control apparatus 300.

The yaw rate sensor 10 detects the yaw rate of the vehicle 1, and outputs a detection signal e corresponding to the detected yaw rate to the alert control apparatus 300.

The lateral acceleration sensor 11 detects a lateral acceleration of the vehicle 1, and outputs a detection signal f corresponding to the detected lateral acceleration to the alert control apparatus 300.

The GPS sensor 12 detects position data about the vehicle 1 based on position measurement signals transmitted from multiple GPS satellites, and outputs a detection signal g including the detected position data to the alert control apparatus 300. A future example of the GPS sensor 12 may be a positioning system using quasi-zenith satellites called a Japanese version GPS.

The exterior view camera 13 captures images in front of the vehicle 1, and outputs an image data signal h including the image data to the alert control apparatus 300.

The exterior sensor 14 includes, for example, an acoustic sensor, a humidity sensor, a temperature sensor, an infrared sensor, or a radar. The exterior sensor 14 is installed at the vehicle exterior to output a sensing signal i corresponding to detected values to the alert control apparatus 300.

The interior-exterior coordinator 15 receives an external signal transmitted wirelessly including surrounding data about the vehicle 1, such as traffic jam information and map data. The interior-exterior coordinator 15 outputs a received signal j to the alert control apparatus 300. Such surrounding data is provided by a vehicle-to-roadside communication system, such as the Vehicle Information and Communication System (VICS, registered trademark) in Japan. In some embodiments, the surrounding data may be transmitted from a beacon, such as a radio wave beacon, installed near a railroad crossing. In some embodiments, the surrounding data may be transmitted from oncoming vehicles through a vehicle-to-vehicle communication system.

The distracted driving alert device 200 is installed in the vehicle interior to generate an alert in response to the warning instruction signal k from the alert control apparatus 300. Examples of an alert include, in addition to a buzzer sound, a display, light emission, vibrations, and communication to mobile terminals.

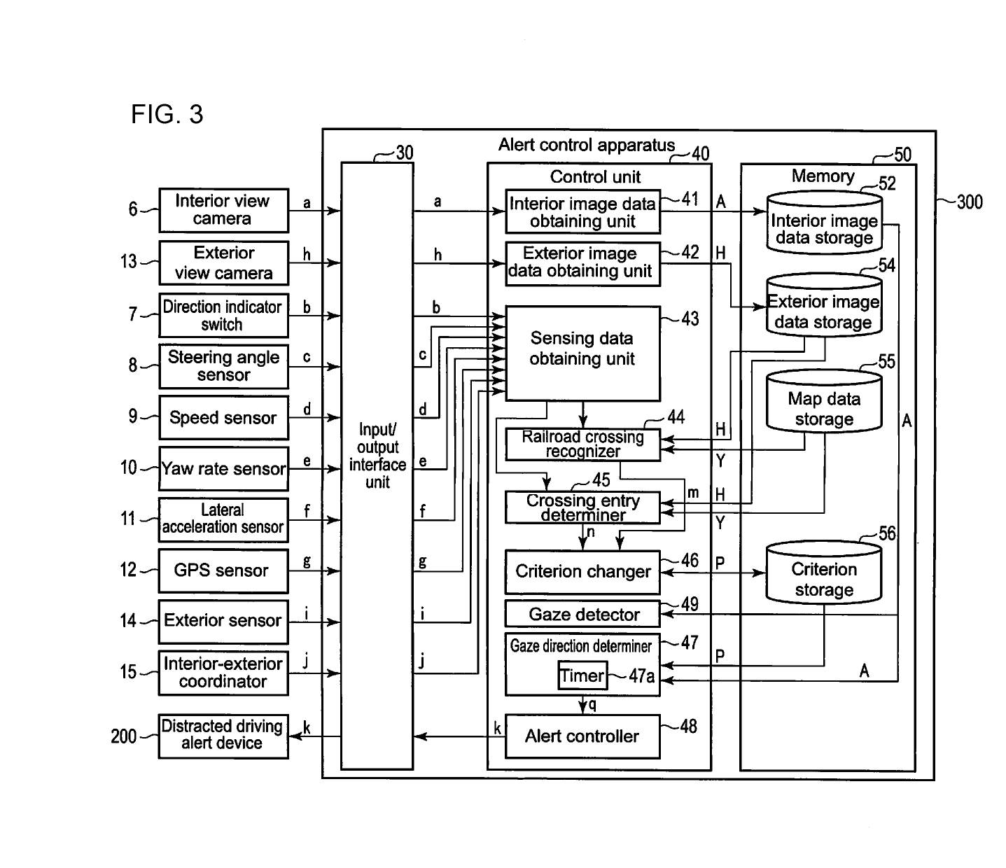

FIG. 3 is a block diagram of the alert control apparatus 300 according to the present embodiment. The alert control apparatus 300 is a computer including a central processing unit (CPU) and a memory. The alert control apparatus 300 includes an input/output interface unit 30, a control unit 40, and a memory 50.

The input/output interface unit 30 receives the image data signal a from the interior view camera 6, the direction indicator signal b from the direction indicator switch 7, the steering angle signal c from the steering angle sensor 8, the detection signal d from the speed sensor 9, the detection signal e from the yaw rate sensor 10, the detection signal f from the lateral acceleration sensor 11, the detection signal g from the GPS sensor 12, the image data signal h from the exterior view camera 13, the sensing signal i from the exterior sensor 14, and the received signal j from the interior-exterior coordinator 15. The input/output interface unit 30, for example, buffers these signals and then transfers them to the control unit 40. The input/output interface unit 30 also outputs a warning instruction signal k received from the control unit 40 to the distracted driving alert device 200.

The memory 50 is, for example, a semiconductor memory, such as a random access memory (RAM), a read only memory (ROM), a flash memory, and a synchronous dynamic RAM (SDRAM), or a non-volatile memory, such as an erasable programmable ROM (EPROM) and an electrically erasable programmable ROM (EEPROM). The memory 50 may also be a storage medium, such as a solid state drive (SSD) and a hard disk drive (HDD). In some embodiments, the memory 50 may be a storage area included in a one-chip microcomputer, such as a field programmable gate array (FPGA).

The memory 50 includes, as storage areas according to the embodiment, an interior image data storage 52, an exterior image data storage 54, a map data storage 55, and a criterion storage 56.

The control unit 40 includes, as functional blocks according to the embodiment, an interior image data obtaining unit 41, an exterior image data obtaining unit 42, a sensing data obtaining unit 43, a railroad crossing recognizer 44, a crossing entry determiner 45, a criterion changer 46, a gaze direction determiner 47, an alert controller 48, and a gaze detector 49. These functional blocks are implemented by the CPU executing programs stored in the program memory.

The interior image data obtaining unit 41 receives the image data signal a transmitted from the interior view camera 6 and output from the input/output interface unit 30, and stores the signal into the interior image data storage 52 as image data A. Thus, the interior image data storage 52 stores the image data A representing the state of the driver.

The exterior image data obtaining unit 42 receives the image data signal h transmitted from the exterior view camera 13 and output from the input/output interface unit 30, and stores the signal into the exterior image data storage 54 as image data H. Thus, the exterior image data storage 54 stores the image data H representing the state of an area in front of the vehicle 1.

The gaze detector 49 detects the gaze or face orientation of the driver from the image data A stored in the interior image data storage 52.

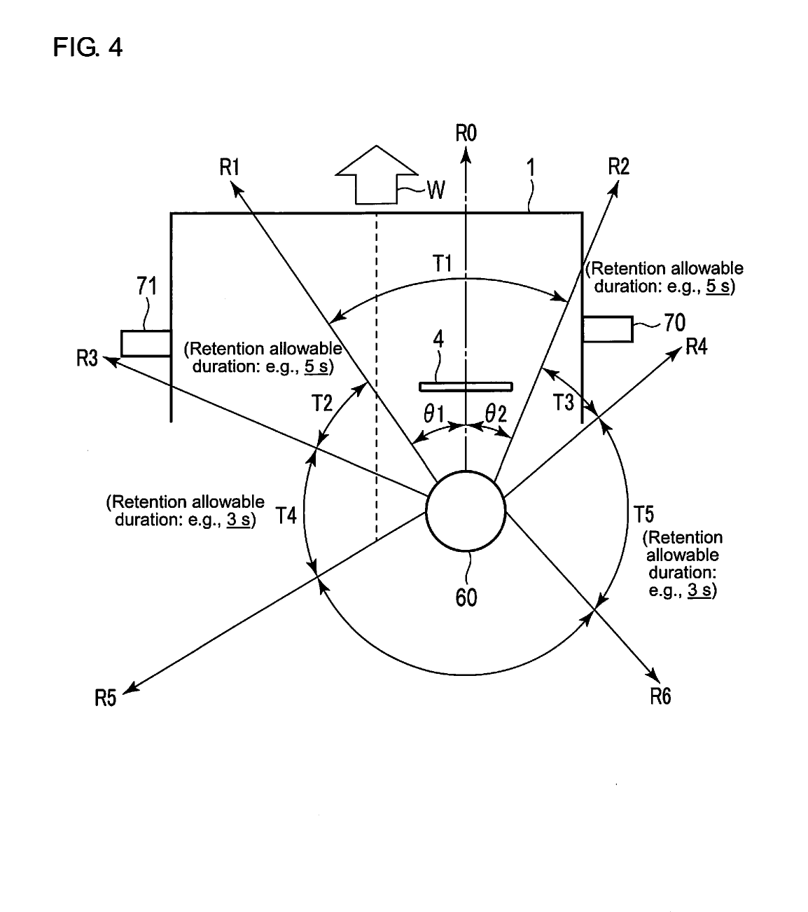

The gaze direction determiner 47 outputs a signal q to the alert controller 48 when detecting distracted driving of a driver 60 based on the gaze or face orientation of the driver detected by the gaze detector 49 and a criterion P stored in the criterion storage 56. The criterion P will now be described with reference to FIG. 4.

FIG. 4 is a schematic diagram describing retention allowable durations as one example of the criterion P. FIG. 4 is a schematic diagram of the vehicle interior viewed from above. FIG. 4 includes a right side mirror 70 and a left side mirror 71.

When the vehicle 1 is traveling straight forward (or upward in the figure) at a normal speed (e.g., 60 km per hour), the gaze direction R of the driver 60 is typically parallel to the traveling direction W of the vehicle 1 or points straight ahead in a gaze direction R0. In this case, the gaze direction R is expected not to deviate leftward from a gaze direction R1 or rightward from a gaze direction R2, although it can slightly move leftward or rightward from the gaze direction R0. A spatial area T1 extends in front of the driver 60.

The driver 60 having his or her gaze direction R within a spatial area different from the area T1 is determined to be engaging in distracted driving. This spatial area is in the direction in which the driver 60 is distracted, or is looking aside (distracted driving direction). The area in the distracted driving direction is not limited to a single area. As shown in FIG. 4, four areas T2 to T5 may be defined in the distracted driving direction. The area T2 is on the left of and adjacent to the area T1. The area T3 is on the right of and adjacent to the area T1. The area T4 is on the rear of and adjacent to the area T2. The area T5 is on the rear of and adjacent to the area T3.

In the example shown in FIG. 4, the area T2 between the gaze directions R1 and R3 and the area T3 between the gaze directions R2 and R4 are asymmetric with respect to the gaze direction R0, and the area T4 between the gaze directions R3 and R5 and the area T5 between the gaze directions R4 and R6 are also asymmetric with respect to the gaze direction R0.

FIG. 4 shows the settings applicable to regions with left-hand traffic. In this example, an angle θ1 between the gaze directions R0 and R1 is greater than an angle θ2 between the gaze directions R0 and R2. The relationship between these angles is reversed in regions with right-hand traffic.

The driver with his or her gaze direction R retained within any of the areas T2 to T5 is determined not to be engaging in distracted driving when the driver changes his or her gaze direction R to another area or to the area T1 in a short time. The length of the retention time set for each area for distracted driving determination herein is referred to as a retention allowable duration. In other words, the retention allowable duration refers to a duration for which the driver 60 is allowed to retain his or her gaze direction R within the same area without activating the distracted driving alert device 200.

The retention allowable duration can be set for each area. In FIG. 4, the retention allowable duration is set at five seconds for the area T2, five seconds for the area T3, three seconds for the area T4, and three seconds for the area T5. The retention allowable durations are extended from predetermined values (default values) when the vehicle 1 passes a railroad crossing. In the present embodiment, the retention allowable durations shown in FIG. 4 are predetermined values.

The gaze direction determiner 47 obtains the image data. A from the interior image data storage 52 and the criterion P from the criterion storage 56, and determines distracted driving of the driver 60 based on the image data A and the criterion P. More specifically, the gaze direction determiner 47 does not detect distracted driving when the gaze direction R determined from the face orientation or gaze of the driver 60 in the image data A is within the area T1.

When the gaze direction R is within any of the areas T2 to T5, the gaze direction determiner 47 activates a built-in timer 47a. The timer 47a then counts the time for which the gaze direction R is retained within the same area. The gaze direction determiner 47 determines whether the count reaches the retention allowable duration set for the corresponding area.

When the driver 60 changes his or her gaze direction R to another area or to the area T1 before the count reaches the retention allowable duration, the gaze direction determiner 47 stops the timer 47a and resets the count.

When the count of the timer 47a reaches the retention allowable duration of the corresponding one of the areas T2 to T5, the gaze direction determiner 47 detects distracted driving, and outputs an activation signal q to the alert controller 48 to activate the distracted driving alert device 200.

In response to the activation signal q output from the gaze direction determiner 47, the alert controller 48 outputs the warning instruction signal k to the input/output interface unit 30. The input/output interface unit 30 outputs the warning instruction signal k to the distracted driving alert device 200.

In response to the warning instruction signal k output from the input/output interface unit 30, the distracted driving alert device 200 generates an alert. When the vehicle 1 has not entered a railroad crossing, the distracted driving alert device 200 generates an alert to distracted driving under control by the alert controller 48. In contrast, either immediately before the vehicle 1 enters a railroad crossing or at least while the vehicle 1 is passing a railroad crossing, the control unit 40 restricts alert generation from the distracted driving alert device 200.

The sensing data obtaining unit 43 receives the direction indicator signal b, the steering angle signal c, the detection signal d, the detection signal e, the detection signal f, the detection signal g, the sensing signal i, and the received signal j output from the input/output interface unit 30, and outputs these signals to the railroad crossing recognizer 44 and the crossing entry determiner 45.

The railroad crossing recognizer 44 recognizes the position of a railroad crossing relative to the vehicle 1 based at least on position information G, traffic and other information J, the image data H stored in the exterior image data storage 54, or map data Y stored in the map data storage 55. When the image data H is used, the gate of the crossing may be recognized using Open Source Computer Vision Library (OpenCV) to recognize, for example, the position of the crossing relative to the vehicle 1. After recognizing a railroad crossing, the railroad crossing recognizer 44 outputs a crossing recognition signal m to the criterion changer 46.

The crossing entry determiner 45 determines whether the vehicle 1 has entered a railroad crossing based at least on the position information G, the map data Y from the map data storage 55, the traffic and other information J, or the image data H from the exterior image data storage 5. When detecting entry of the vehicle 1 into the railroad crossing, the crossing entry determiner 45 outputs, a determination signal n to the criterion changer 46.

When receiving the determination signal n from the crossing entry determiner 45, the criterion changer 46 obtains the criterion P from the criterion storage 56, relaxes the criterion P, and then returns it to the criterion storage 56. The criterion P stored in the criterion storage 56 is updated accordingly.

Relaxing the criterion P includes extending the retention allowable durations from the predetermined values, for example, shown in FIG. 4. In some embodiments, extending the retention allowable duration sufficiently from the duration taken to pass a railroad crossing can mask an alert to distracted driving.

As described above, extending retention allowable durations sufficiently can restrict generation of an alert to distracted driving. The criterion changer 46 restricts alert generation by changing the criterion P. In other words, the criterion changer 46 serves as a restrictor that restricts alert generation from the distracted driving alert device 200 for distracted driving of a driver based on a recognition result from the railroad crossing recognizer 44 while the vehicle 1 is passing a railroad crossing. More embodiments based on the above structure will now be described.

### FIRST EMBODIMENT

### Operation

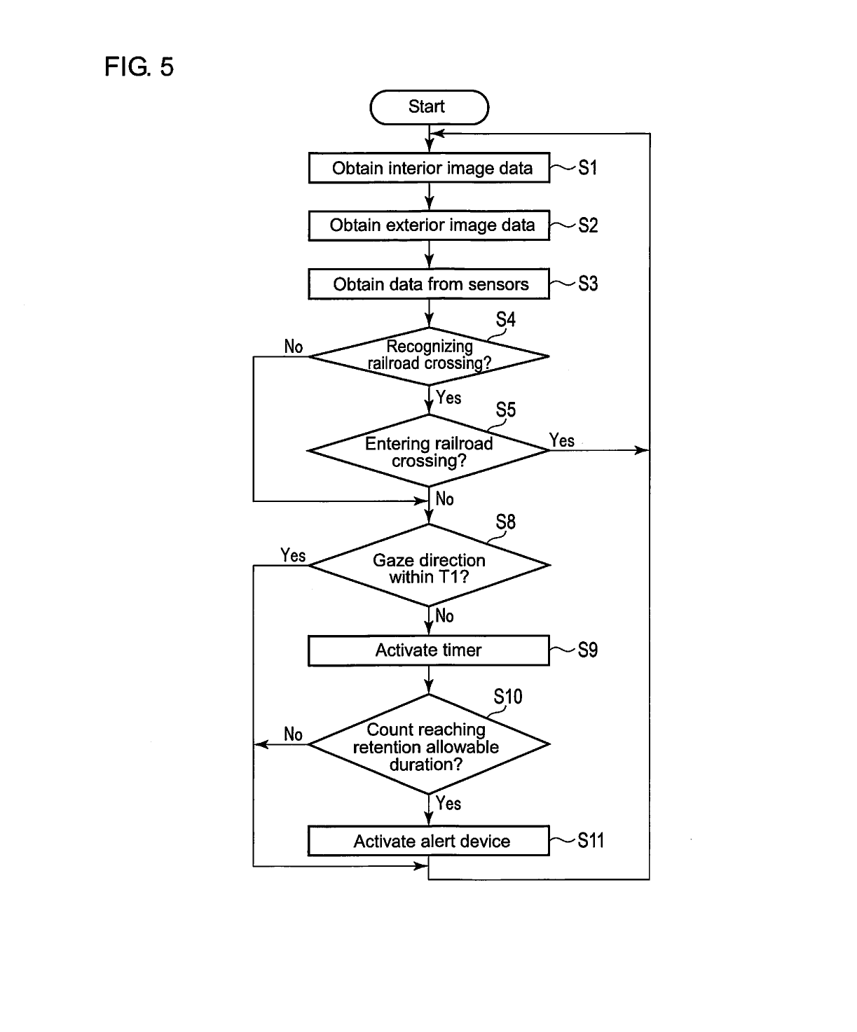

FIG. 5 is a flowchart showing an example procedure performed by the alert control apparatus according to one or more embodiments. In FIG. 5, the interior view camera 6 captures images of the driver 60, and outputs the image data signal a to the alert control apparatus 300. The image data signal a is transferred to the interior image data obtaining unit 41 through the input/output interface unit 30, and is converted into the image data A and stored in the interior image data storage 52 (S1).

The exterior view camera 13 captures images in front of the vehicle 1, and outputs the image data signal h to the alert control apparatus 300. The image data signal h is transferred to the exterior image data obtaining unit 42 through the input/output interface unit 30, and is converted into the image data H and stored in the exterior image data storage 54 (S2).

Further, the signals corresponding to the results detected by the direction indicator switch 7, the steering angle sensor 8, the speed sensor 9, the yaw rate sensor 10, the lateral acceleration sensor 11, the GPS sensor 12, and the exterior sensor 14, as well as the received signal received by the interior-exterior coordinator 15 are also output to the alert control apparatus 300. These signals are obtained by the sensing data obtaining unit 43 through the input/output interface unit 30 (S3).

Through the above processing, the sensing data obtaining unit 43 obtains direction indicator information B from the direction indicator signal b, steering angle information C from the steering angle signal c, speed information D from the detection signal d, yaw rate information E from the detection signal e, lateral acceleration information F from the detection signal f, the position information G from the detection signal g, distance information I from the sensing signal i, and the traffic and other information J from the received signal j. Steps S1 to S3 may not be performed in the order illustrated in the figure. In the processing performed by the processor, steps S1 to S3 are performed substantially in parallel.

For a railroad crossing in front of the vehicle 1 in the traveling direction, the railroad crossing recognizer 44 recognizes the railroad crossing based at least on the position information G, the traffic and other information J, the image data H, or the map data Y (Yes in step S4). The railroad crossing recognizer 44 then outputs the crossing recognition signal m to the criterion changer 46. The processing then advances to step S5.

When no railroad crossing is in front of the vehicle 1 in the traveling direction, the railroad crossing recognizer 44 does not recognize any railroad crossing (No in step S4). The processing then advances to step S8.

In step S5, the crossing entry determiner 45 determines whether the vehicle 1 enters the railroad crossing (S5). The crossing entry determiner 45 compares the position data about the vehicle 1 and the position data about the railroad crossing included in the map data, and determines that the vehicle 1 has entered the railroad crossing when the position of the vehicle 1 matches the coordinates indicating the position of the railroad crossing (Mode 1).

In some embodiments, the crossing entry determiner 45 detects entry into the railroad crossing based on the exterior image data H that has undergone image processing. For example, the crossing entry determiner 45 determines that the vehicle 1 has entered the railroad crossing when the railroad crossing is detected through image processing of the exterior image data H (Mode 2).

In some embodiments, the crossing entry determiner 45 detects entry into the railroad crossing based on the surrounding data about the vehicle 1 obtained by the interior-exterior coordinator 15. For example, the crossing entry determiner 45 determines that the vehicle 1 has entered the railroad crossing when the surrounding data indicates the vehicle 1 currently passing the railroad crossing (Mode 3).

When the crossing entry determiner 45 detects no entry of the vehicle 1 into the railroad crossing in step S5 (No in step S5), the gaze direction determiner 47 determines the gaze direction R of the driver 60 from the face orientation or gaze of the driver 60 in the image data A (S8). When the gaze direction R is retained within the area T1 (Yes in step S8), the gaze direction determiner 47 determines not to activate the distracted driving alert device 200. The processing then returns to step S1.

When the gaze direction R is retained within any of the areas T2 to T5 (No in step S8), the gaze direction determiner 47 activates the timer 47a (S9). The timer 47a then counts the time for which the gaze direction R is retained within the same area. The gaze direction determiner 47 then determines whether the count reaches the retention allowable duration set for the corresponding area (S10).

When the driver 60 changes his or her gaze direction R to another area or to the area T1 before the count reaches the retention allowable duration (No in step S10), the count is reset. The processing then returns to step 51. In this case, no alert is generated.

When the count of the timer 47a reaches the retention allowable duration (Yes in step S10), the gaze direction determiner 47 outputs the activation signal q to the alert controller 48. In response to the activation signal q, the alert controller 48 outputs the warning instruction signal k to the distracted driving alert device 200 through the input/output interface unit 30. The distracted driving alert device 200 generates an alert (S11).

In step S5, when the crossing entry determiner 45 detects entry of the vehicle 1 into the railroad crossing based on any of the modes 1 to 3 or any combination of these (Yes in step S5), the crossing entry determiner 45 returns the processing back to the first processing. Thus, the processing from steps S8 to S11 is skipped, and no alert is generated from the distracted driving alert device 200. In other words, alert generation is restricted.

### Advantages and Effects

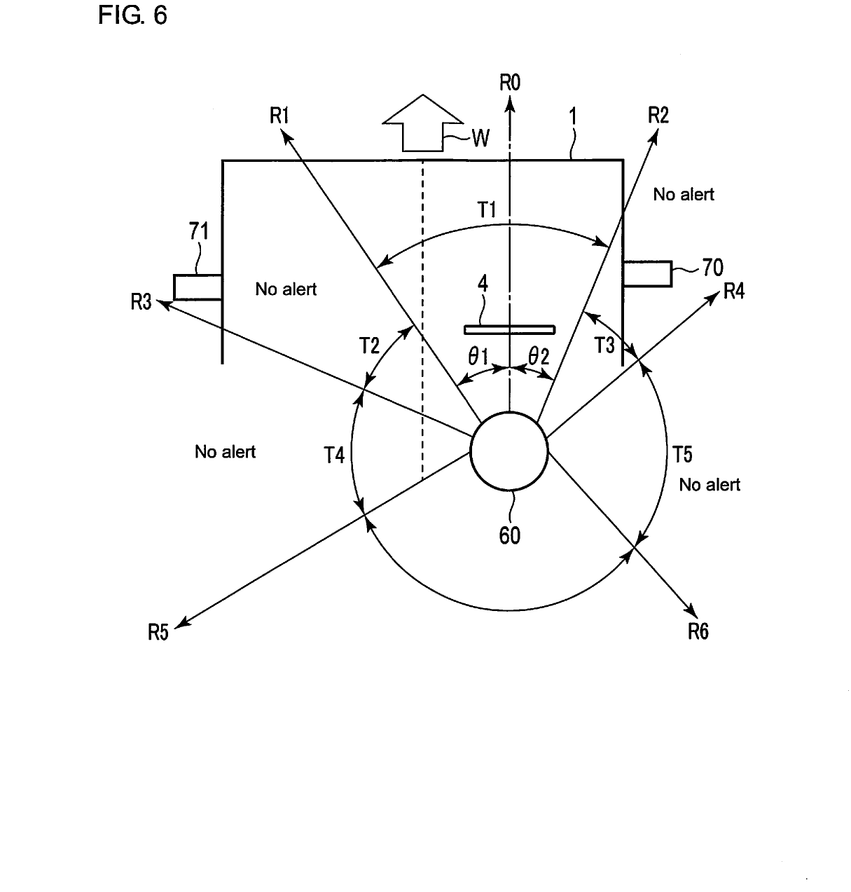

FIG. 6 is a schematic diagram showing the control for restricting an alert to distracted driving. The processing associated with distracted driving determination is skipped upon detecting entry of the vehicle 1 into a railroad crossing. This prevents an alert from being generated for any one of the areas T2, T3, T4, and T5. This control equates to disable the alert device.

As described above, the structure according to the present embodiment restricts alert generation from the alert device when the vehicle passes a railroad crossing. Thus, the alert device included in the vehicle can be controlled effectively without disturbing the driver when the vehicle passes a railroad crossing. The processing step S8 and subsequent steps in FIG. 5 is performed when no entry into a railroad crossing is detected, thus enabling the distracted driving alert device to maintain its function.

### SECOND EMBODIMENT

### Operation

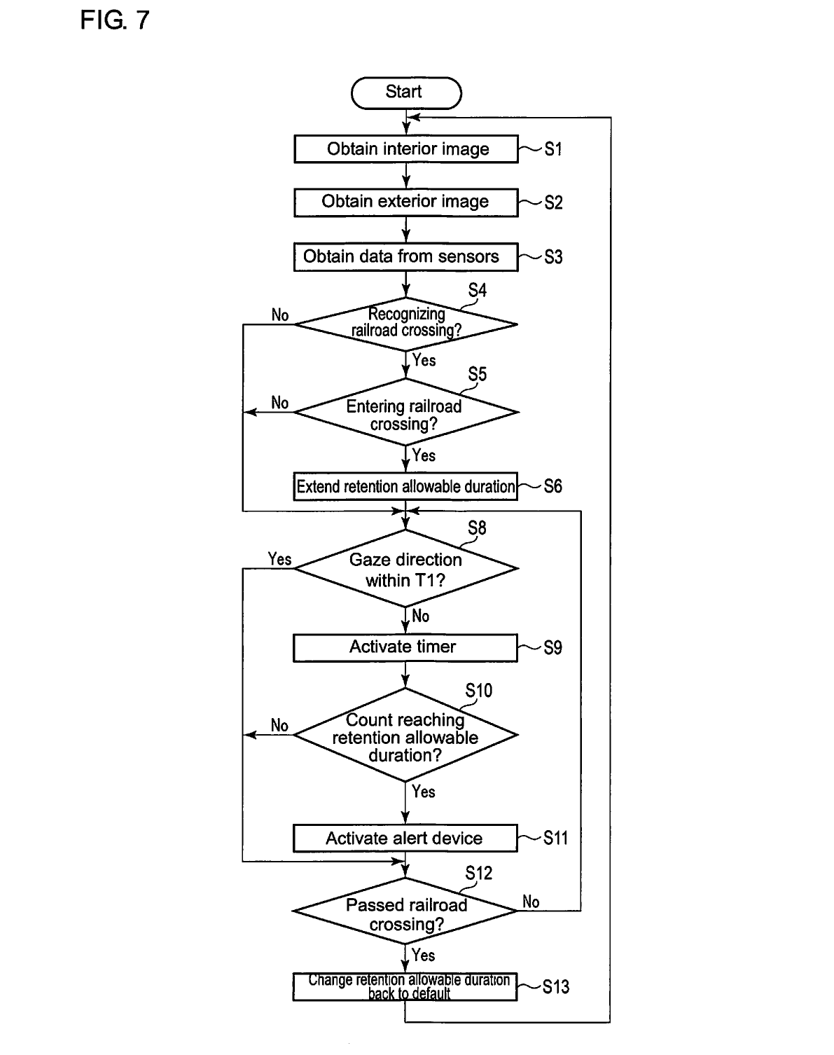

FIG. 7 is a flowchart showing another example procedure performed by the alert control apparatus according to one or more embodiments. FIG. 7 differs from FIG. 5 in that the processing advances to step S6 and then to step S8 upon detecting entry into a railroad crossing in step S5 (Yes).

In step S5, when detecting entry of the vehicle 1 into the railroad crossing (Yes in step S5), the crossing entry determiner 45 outputs the determination signal n to the criterion changer 46. The criterion changer 46 then extends the retention allowable durations set for the areas T2 to T5 shown in FIG. 4 (S6). The retention allowable durations may be extended in seconds, or for example in minutes or hours. More specifically, when the entry into the railroad crossing is detected, step S8 and subsequent steps are performed using the criterion P relaxed in step S6.

When the gaze direction R is retained within any of the areas T2 to T5 in step S8 (No in step S8), the timer 47a is activated (S9). The timer 47a then counts the time for which the gaze direction R is retained within the same area. The gaze direction determiner 47 then determines whether the count reaches the retention allowable duration set for the corresponding area (S10).

The retention allowable duration is extended long enough to cause a timeout in step S10 (No in step S10), the processing advances to step S12 without generating an alert. In this case, step Sib is skipped, and no alert is generated.

When the crossing entry determiner 45 determines that the vehicle 1 finishes passing the railroad crossing in step S12 (Yes in step S12), the criterion changer 46 changes the determination criteria changed in step S6 back to the default values in step S13. When the crossing entry determiner 45 does not determine that the vehicle 1 finishes passing the railroad crossing (No in step S12), the processing returns to step S8 and the processing from steps S8 to S12 is repeated.

### Advantages and Effects

In step S6, the criterion changer 46 extends the retention allowable durations set for the areas T2 to T5 sufficiently (in minutes for example) from the duration taken to pass the railroad crossing. This prevents an alert from being generated for any of the areas T2, T3, T4, and T5 as shown in FIG. 6. In other words, extending the retention allowable duration from the predetermined value equates to disable the alert device.

As described above, the structure according to the second embodiment also restricts alert generation from the alert device when the vehicle passes a railroad crossing. Thus, the alert device included in the vehicle can be controlled effectively without disturbing the driver when the vehicle passes a railroad crossing.

The present invention should not be limited to the above embodiments. In the second embodiment, the retention allowable duration is extended in step S6 upon detection of the vehicle 1 entering a railroad crossing. In some embodiments, the retention allowable duration may be extended when the vehicle 1 reaches a stop position before entering a railroad crossing. This restricts an alert to distracted driving before the vehicle 1 enters a railroad crossing.

In some embodiments, the non-distracted driving area T1, which is set in front of the vehicle, may be expanded to include the areas T2 and T3 or further to include the areas T4 and T5 to restrict alert generation in all the areas as shown in FIG. 6.

The alert control apparatus according to each of the above embodiments and its components may be implemented by hardware or a combination of hardware resources and software. The software to be combined is a program preliminarily installed in a computer through a network or from a computer readable recording medium, and executed by a processor included in the computer to perform the operation of each unit.

A processor used in association with a computer or the term processor herein includes a circuit such as a CPU, a graphics processing unit (GPU), an application specific integrated circuit (ASIC), a simple programmable logic device (SPLD), a complex programmable logic device (CPLD), and an FPGA.

The processor reads a program stored in the memory and executes the program to implement the specific processing based on the program. The program may not be stored in the memory but may be directly incorporated in the circuit of the processor. In that case, the processor reads the program incorporated in the circuit to perform the processing.

Although the present invention has been described based on the specific embodiments with reference to the drawings, the present invention is not limited to the above embodiments. Variations and modifications will occur to those skilled in the art within the spirit and scope of the present invention defined by the claims. Such variations and modifications can fall within the technical scope of the present invention.

The present embodiment may be partially or entirely expressed in, but not limited to, the following forms shown in the appendixes below.

### APPENDIX 1

An alert control apparatus installable in a vehicle to control an alert device that alerts a driver, the apparatus comprising a hardware processor configured to
obtain sensing data from a sensor included in the vehicle;
detect a gaze or a face orientation of the driver based on the obtained sensing data;
determine distracted driving of the driver based on the detected gaze or face orientation and a determination criterion for detecting distracted driving of the driver;
cause the alert device to generate an alert in response to detection of distracted driving;
recognize a position of a railroad crossing relative to the vehicle based on the obtained sensing data; and
restrict generation of the alert to distracted driving of the driver from the alert device based on a recognition result while the vehicle is passing the railroad crossing.

### APPENDIX 2

An alert control method implemented by an alert control apparatus installable in a vehicle to control an alert device that alerts a driver, the method comprising:
obtaining, with at least one hardware processor, sensing data from a sensor included in the vehicle;
detecting, with the at least one hardware processor, a gaze or a face orientation of the driver based on the obtained sensing data;
determining, with the at least one hardware processor, distracted driving of the driver based on the detected gaze or face orientation and a determination criterion for detecting distracted driving of the driver;
causing, with the at least one hardware processor, the alert device to generate an alert in response to detection of distracted driving;
recognizing, with the at least one hardware processor, a position of a railroad crossing relative to the vehicle based on the obtained sensing data; and
restricting, with the at least one hardware processor, generation of the alert to distracted driving of the driver from the alert device based on a recognition result while the vehicle is passing the railroad crossing.

### REFERENCE SIGNS LIST

1: vehicle, 2: power unit, 3: steering unit, 4: steering wheel, 5: exterior image data storage, 6: interior view camera, 7: direction indicator switch, 8: steering angle sensor, 9: speed sensor, 10: yaw rate sensor, 11: lateral acceleration sensor, 12: GPS sensor, 13: exterior view camera, 14: exterior sensor, 15: interior-exterior coordinator, 30: input/output interface unit, 40: control unit, 41: interior image data obtaining unit, 42: exterior image data obtaining unit, 43: sensing data obtaining unit, 44: railroad crossing recognizer, 45: crossing entry determiner, 46: criterion changer, 47: gaze direction determiner, 47a: built-in timer, 48: alert controller, 49: gaze detector, 50: memory, 52: interior image data storage, 54: exterior image data storage, 55: map data storage, 56: criterion storage, 60: driver, 70: right side mirror, 71: left side mirror, 100: sensor, 200: distracted driving alert device, 300: alert control apparatus

1. An alert control apparatus installable in a vehicle to control an alert device that alerts a driver, the apparatus comprising:
a data obtaining unit configured to obtain sensing data from a sensor included in the vehicle;
a gaze detector configured to detect a gaze or a face orientation of the driver based on the obtained sensing data;
a distracted driving determiner configured to determine distracted driving of the driver based on the detected gaze or face orientation and a determination criterion for detecting distracted driving of the driver;
a controller configured to cause the alert device to generate an alert in response to detection of distracted driving;
a railroad crossing recognizer configured to recognize a position of a railroad crossing relative to the vehicle based on the obtained sensing data; and
a restrictor configured to restrict, based on a recognition result from the railroad crossing recognizer, generation of the alert to distracted driving of the driver from the alert device while the vehicle is passing the railroad crossing.

2. The alert control apparatus according to claim 1, wherein
the restrictor changes the determination criterion to a criterion with which the alert is less likely to be generated while the vehicle is passing the railroad crossing than at other times.

3. The alert control apparatus according to claim 2, wherein
the determination criterion includes a retention allowable duration for which the driver is allowed to retain a gaze or a face orientation within an imaginary area defined for detecting distracted driving, and
the restrictor extends the retention allowable duration from a predetermined value.

4. The alert control apparatus according to claim 1, further comprising:
a storage configured to store map data including at least position data about the railroad crossing, wherein
the sensing data includes position data about the vehicle,
the data obtaining unit obtains the position data about the vehicle based on a positioning signal from a positioning system, and
the railroad crossing recognizer recognizes the position of the railroad crossing relative to the vehicle based on the obtained position data about the vehicle and the position data about the railroad crossing included in the map data.

5. The alert control apparatus according to claim 1, wherein
the vehicle includes an exterior view camera configured to obtain image data about a view external to the vehicle,
the data obtaining unit obtains the image data from the exterior view camera, and
the railroad crossing recognizer subjects the image data to image processing, and uses the processed image data to recognize the position of the railroad crossing relative to the vehicle.

6. The alert control apparatus according to claim 1, wherein
the vehicle is configured to communicate with a vehicle-to-roadside communication system or a vehicle-to-vehicle communication system,
the data obtaining unit obtains surrounding data about the vehicle from the communication system, and
the railroad crossing recognizer recognizes the position of the railroad crossing relative to the vehicle based on the surrounding data.

7. An alert control method implemented by an alert control apparatus installable in a vehicle to control an alert device that alerts a driver, the method comprising:
obtaining, with the alert control apparatus, sensing data from a sensor included in the vehicle;
detecting, with the alert control apparatus, a gaze or a face orientation of the driver based on the obtained sensing data;
determining, with the alert control apparatus, distracted driving of the driver based on the detected gaze or face orientation and a determination criterion for detecting distracted driving of the driver;
causing, with the alert control apparatus, the alert device to generate an alert in response to detection of distracted driving;
recognizing, with the alert control apparatus, a position of a railroad crossing relative to the vehicle based on the obtained sensing data; and
restricting, with the alert control apparatus, generation of the alert to distracted driving of the driver from the alert device based on a recognition result while the vehicle is passing the railroad crossing.

8. A non-transitory recording medium having a program recorded thereon that is executable to cause a computer to implement processes performed by the units included in the alert control apparatus according to claim 1.

9. A non-transitory recording medium having a program recorded thereon that is executable to cause a computer to implement processes performed by the units included in the alert control apparatus according to claim 2.

10. A non-transitory recording medium having a program recorded thereon that is executable to cause a computer to implement processes performed by the units included in the alert control apparatus according to claim 3.

11. A non-transitory recording medium having a program recorded thereon that is executable to cause a computer to implement processes performed by the units included in the alert control apparatus according to claim 4.

12. A non-transitory recording medium having a program recorded thereon that is executable to cause a computer to implement processes performed by the units included in the alert control apparatus according to claim 5.

13. A non-transitory recording medium having a program recorded thereon that is executable to cause a computer to implement processes performed by the units included in the alert control apparatus according to claim 6.
